(19) United States
(12) Patent Application Publication
(10) Pub. No.: US 2005/0128093 A1
(43) Pub. Date: Jun. 16, 2005

(54) Self-protected fire-sensing alarm apparatus and method

(76) Inventors: James J. Genova, Woodbridge, VA (US); Laura Simkins, Clarksburg, MD (US); Stephen C. Kenyon, Fairfax, VA (US)

Correspondence Address: KATTEN MUCHIN ZAVIS ROSENMAN, 525 WEST MONROE STREET, CHICAGO, IL, 60661-3693, US

(21) Appl. No.: 10/735,718

(22) Filed: Dec. 16, 2003

(51) Int. Cl. G08B 17/12

(52) U.S. Cl. 340/577; 340/507; 340/568.1; 340/522; 340/600; 340/539.22

(57) ABSTRACT

A self-protected fire-sensing alarm system includes a flame sensor for detecting the presence of flame within a volume. The system includes a tamper sensor for detecting tampering to the system. The tampering prevents the system from detecting the presence of flame within the volume. The system also includes an alarm indicator for indicating an alarm condition in response to i.) a detection of the presence of flame within the volume and/or ii.) a detection of tampering to the system.

### BACKGROUND

1. Field of the Invention

The present invention relates generally to flame or fire detection systems. More particularly, the present invention relates to a self-protected fire-sensing alarm that can detect and counter actions designed to degrade the fire detection performance of the alarm.

2. Background Information

There are many places where smoking or the lighting of matches and lighters is prohibited. This prohibition can result from, for example, a decision of the persons responsible for the room, compliance with local non-smoking laws or ordinances, or an incentive from an insurance carrier. The prohibition can also be the result of a concern for personal health and or the need to protect property. “No Smoking” areas can include public rest rooms and other areas of public schools, restaurants, office buildings, aircraft, airports, and the like. In addition, recent concerns related to the lighting of matches on aircraft are based on, for example, the fear of possible attempts to ignite a bomb or fire aboard a commercial aircraft.

Smoke detectors and/or flame detectors can be located in any or all of the aforementioned areas, rooms or other enclosed spaces. These devices generally provide a means to detect smoke or flame and notify those in the area via an alarm. In some instances, the notification can be sent to a remote location via a wire or wireless communications device, such as described in, for example, U.S. Pat. Nos. 6,195,003, 6,239,697 and 6,281,791.

Smoke detectors can use light scattering or other means to sense the smoke associated with a fire. Smoke detectors are described in, for example, U.S. Pat. No. 6,195,014. These devices generally require concentrations of smoke that are associated with a significant fire located in the room or vicinity. These smoke detectors are useful to save lives and property from fires that are not controlled.

Flame detectors make use of radiation emissions associated with flame. Flame detectors are described in, for example, U.S. Pat. Nos. 5,959,589 and 6,239,433. Radiation emissions that can be detected by flame detectors include, for example, infrared and ultraviolet radiation. The response time of flame detectors can be faster than that of smoke detectors and the probability of detection is better than smoke detectors since the flame detectors detect the flame emissions rather than the build-up of smoke. In particular environments, multiple wavelengths and statistical fluctuations can be used to reduce false alarms. Flame detectors that detect multiple wavelengths can be used in areas with, for example, explosive materials to reduce hazardous explosions. These multiple wavelength detection systems can be more expensive than smoke detectors or flame detectors using a single wavelength.

To be useful, the sensor systems can be coupled to an alerting system. Some alerting systems can use audible or visible signals to alert persons in the area of the danger. The alert can be local to the sensor. Alternatively, the alert can be sent via a wired or wireless transmission to a remote location, for example, to notify security personnel of the hazard.

To reduce missed detections and improve reliability, alarm systems have been designed with, for example, self-testing circuits or low battery indicators. However, a person attempting to smoke a cigarette or cause fire damage through the use of a flame may want to willfully and deliberately violate the prohibition against smoking and/or the use of flame in the given area. If aware of the presence of a monitoring device in the area, a person may attempt to deliberately negate the performance of such detectors placed in the area to monitor for an event related to fire or flame.

To counter such attempts at negating the performance of the smoke detector, the case of a smoke detector can be redesigned to prevent persons from placing a cup or plastic bag over the sensor in such a manner as to block smoke from entering the detector, as described, for example, in U.S. Pat. No. 5,339,072.

Existing smoke and/or flame detection devices are generally vulnerable to deliberate attempts to negate the performance of such a detector. Such attempts can include, for example, covering the sensing element, and smashing, removing, or otherwise damaging the detector.

### SUMMARY OF THE INVENTION

A self-protected fire-sensing alarm system and method are disclosed. In accordance with exemplary embodiments, according to a first aspect of the present invention, the fire-sensing apparatus includes a flame sensor for detecting a presence of flame within a volume. The flame sensor can detect ultraviolet energy generated by flame to detect the presence of flame, but be insensitive to electromagnetic radiation that normally occurs within the volume. The apparatus can also include a smoke sensor for detecting the presence of smoke within the volume. The apparatus includes a tamper sensor for detecting tampering to the apparatus. The tampering prevents the apparatus from detecting the presence of flame within the volume. The tamper sensor can include a motion sensor for detecting motion to the apparatus, which can indicate an attempt to tamper with the apparatus. The tamper sensor can also include a visible light sensor. An absence of visible light to the visible light sensor can indicate an attempt to tamper with the apparatus. The visible light sensor can include means for generating electrical energy from the visible light that can be used to charge a power supply for powering the apparatus.

According to the first aspect, the apparatus includes an alarm indicator for indicating an alarm condition in response to i.) a detection of the presence of flame within the volume and/or ii.) a detection of tampering to the apparatus. The alarm indicator can indicate the alarm condition to persons within a vicinity of the apparatus using an audible alarm, a visual alarm and/or a tactile alarm. The apparatus can also include a transmitter for transmitting the alarm condition to a remote monitor. Receipt of the alarm condition by the remote monitor generates an audible alarm, a visual alarm and/or a tactile alarm at the location of the remote monitor to indicate the alarm condition to the remote monitor, such as remotely monitoring persons. The transmitter can also transmit a status message to the remote monitor at periodic intervals. The status message can include, for example, information for identifying the location of the source of the status message, the existence of the alarm condition, and the type of alarm condition. An alarm condition can be indicated if the remote monitor does not receive the status message within the periodic interval, and an audible alarm, visual alarm and/or tactile alarm can be generated at the location of the remote monitor to indicate the alarm condition. To camouflage the apparatus, the apparatus can have the appearance of an object used for a different purpose within the volume. The apparatus can also be resistant to shock which can be indicative of an attempt to tamper with the apparatus. One or more of the apparatus can be positioned within the volume to monitor the contents of the volume.

According to a second aspect of the present invention, a fire-sensing system includes a fire sensor for detecting the presence of flame and/or smoke within the volume. The fire sensor can include a flame sensor for detecting ultraviolet energy generated by flame, where the flame sensor is insensitive to electromagnetic radiation that normally occurs within the volume. The fire sensor can also include a smoke sensor for detecting the presence of smoke within the volume. The system includes tamper countering structure for countering attempts to prevent the fire sensor from detecting the presence of flame and/or smoke within the volume. The tamper countering structure can include a motion sensor for detecting motion to the system and/or a visible light sensor. For example, an absence of visible light to the visible light sensor can be indicative of an attempt to tamper with the system. The visible light sensor can also include means for generating electrical energy from visible light that can be used to charge a power supply used to power the system. The attempt countering structure can also include camouflage for camouflaging the appearance of the system by providing the system with the appearance of an object used for a different purpose within the volume. The attempt countering structure can also include a shock-resistant enclosure for the system for protecting the system against shock.

According to the second aspect, the system includes a transmitter for transmitting an alarm notification upon detection of i.) the presence of at least one of flame and smoke within the volume and/or ii.) an attempt to prevent the fire sensor from detecting the presence of the at least one of flame and smoke within the volume. The transmitter can transmit the alarm notification to persons within the vicinity of the system using an audible alarm, a visual alarm and/or a tactile alarm. The transmitter can also transmit the alarm notification to a remote monitor. Receipt of the alarm notification by the remote monitor can generate an audible alarm, a visual alarm and/or a tactile alarm at the remote monitor's location to indicate the alarm notification to the remote monitor. The transmitter can also transmit a status message to the remote monitor at periodic intervals. An alarm condition can be indicated if the remote monitor does not receive the status message within the periodic interval, and an audible alarm, visual alarm and/or tactile alarm can be generated at the location of the remote monitor to indicate the alarm condition.

According to a third aspect of the present invention, a method for sensing fire within a volume comprises the steps of: i.) detecting a presence of flame within the volume; ii.) detecting tampering that prevents a detection of the presence of flame within the volume; and iii.) indicating an alarm condition in response to a.) the detection of the presence of flame within the volume and/or b.) the detection of tampering that prevents the detection of the presence of the flame within the volume. The method can also comprise the step of detecting the presence of smoke within the volume, wherein the step of indicating an alarm condition can further comprise the step of indicating the alarm condition in response to the detection of the presence of smoke within the volume. The method can also comprise the step of transmitting a status message to a remote monitor at periodic intervals. An alarm condition can be indicated if the remote monitor does not receive the status message within the periodic interval, and the step of transmitting the status message can include the step of generating an audible alarm, visual alarm and/or tactile alarm at the location of the remote monitor to indicate the alarm condition.

According to the third aspect, the step of detecting the presence of flame within the volume can include the steps of: i.) detecting ultraviolet energy generated by flame; and ii.) ignoring electromagnetic radiation that normally occurs within the volume. The step of detecting tampering can include the steps of: i.) detecting motion, where the motion can indicate tampering; and ii.) detecting an absence of visible light, where an absence of visible light can indicate tampering. The step of detecting an absence of visible light can include the step of generating electrical energy from the visible light to supply power to charge a power supply. The step of indicating an alarm condition can include the steps of: i.) indicating an alarm condition to persons within the vicinity of the volume using an audible alarm, a visual alarm and a tactile alarm; and ii.) transmitting the alarm condition to a remote monitor. The step of transmitting the alarm condition can include the step of generating an audible alarm, a visual alarm and/or a tactile alarm at the location of the remote monitor, upon receipt of the alarm condition by the remote monitor, to indicate the alarm condition to the remote monitor. The method can also include the step of countering attempts at tampering that prevent the detection of the presence of flame within the volume. For example, the step of countering attempts at tampering can include the steps of: i.) creating camouflage that has the appearance of an object used for a different purpose within the volume; and ii.) resisting shock that can be indicative of attempts at tampering.

According to a fourth aspect of the present invention, a method for sensing fire within a volume comprises the steps of: i.) detecting a presence of at least one of flame and smoke within the volume; ii.) countering attempts to prevent a detection of the presence of the at least one of flame and smoke within the volume; and iii.) transmitting an alarm notification upon detection of a.) the presence of the at least one of flame and smoke within the volume and/or ii.) an attempt to prevent the detection of the presence of the at least one of flame and smoke within the volume. The step of detecting the presence of flame and/or smoke can include the steps of: i.) detecting ultraviolet energy generated by flame to detect the presence of flame; ii.) ignoring electromagnetic radiation that normally occurs within the volume; and iii.) detecting the presence of smoke within the volume. The step of countering attempts can include the steps of: i.) detecting motion that can be indicative of an attempt to prevent the detection of the flame and/or smoke; ii.) detecting an absence of visible light, where the absence of visible light can be indicative of an attempt to prevent the detection of the flame and/or smoke; iii.) creating camouflage that has an appearance of an object used for a different purpose within the volume; and iv.) resisting shock that can be indicative of an attempt to prevent the detection of the flame and/or smoke. The step of detecting an absence of visible light can include the step of generating electrical energy from the visible light that can be used to charge a power supply.

According to the fourth aspect, the step of transmitting an alarm notification can include the steps of: i.) transmitting an alarm notification to persons within the vicinity of the volume, using an audible alarm, a visual alarm and/or a tactile alarm; and ii.) transmitting the alarm notification to a remote monitor. The step of transmitting the alarm notification to the remote monitor can include the step of generating an audible alarm, a visual alarm and/or a tactile alarm at the remote monitor's location, upon receipt of the alarm notification by the remote monitor, to indicate the alarm condition to the remote monitor. The method can also include the step of transmitting a status message to the remote monitor at periodic intervals. The absence of receipt of the status message by the remote monitor within the periodic interval can be indicative of an alarm condition. In such a situation, the step of transmitting a status message can include the step of generating an audible alarm, a visual alarm and/or a tactile alarm at the location of the remote monitor to indicate the alarm condition to the remote monitor.

According to a fifth aspect of the present invention, a system for sensing fire within a volume comprises means for detecting a presence of flame within the volume, means for detecting tampering that prevents a detection of the presence of flame within the volume, and means for indicating an alarm condition in response to a.) the detection of the presence of flame within the volume and/or b.) the detection of tampering that prevents the detection of the presence of the flame within the volume. The system can also comprise means for detecting the presence of smoke within the volume, wherein the means for indicating an alarm condition can indicate the alarm condition in response to the detection of the presence of smoke within the volume. The system can also comprise means for transmitting a status message to a remote monitor at periodic intervals. An alarm condition can be indicated if the remote monitor does not receive the status message within the periodic interval, and the system can include means for generating an audible alarm, visual alarm and/or tactile alarm at the location of the remote monitor to indicate the alarm condition.

According to the fifth aspect, the means for detecting the presence of flame within the volume can include means for detecting ultraviolet energy generated by flame, but which ignores electromagnetic radiation that normally occurs within the volume. The means for detecting tampering can include means for detecting motion, where the motion can indicate tampering, and means for detecting an absence of visible light, where an absence of visible light can indicate tampering. The means for detecting an absence of visible light can include means for generating electrical energy from the visible light to supply power to charge a power supply. The means for indicating an alarm condition can include means for indicating an alarm condition to persons within the vicinity of the volume using an audible alarm, a visual alarm and a tactile alarm, and means for transmitting the alarm condition to a remote monitor. The system can include means for generating an audible alarm, a visual alarm and/or a tactile alarm at the location of the remote monitor, upon receipt of the alarm condition by the remote monitor, to indicate the alarm condition to the remote monitor. The system can also include means for countering attempts at tampering that prevent the detection of the presence of flame within the volume. For example, the means for countering attempts at tampering can include means for creating camouflage that has the appearance of an object used for a different purpose within the volume, and means for resisting shock that can be indicative of attempts at tampering.

According to a sixth aspect of the present invention, a system for sensing fire within a volume comprises means for detecting a presence of at least one of flame and smoke within the volume, means for countering attempts to prevent a detection of the presence of the at least one of flame and smoke within the volume, and means for transmitting an alarm notification upon detection of a.) the presence of the at least one of flame and smoke within the volume and/or ii.) an attempt to prevent the detection of the presence of the at least one of flame and smoke within the volume. The means for detecting the presence of flame and/or smoke can include means for detecting ultraviolet energy generated by flame to detect the presence of flame, but which ignores electromagnetic radiation that normally occurs within the volume, and means for detecting the presence of smoke within the volume. The means for countering attempts can include: means for detecting motion that can be indicative of an attempt to prevent the detection of the flame and/or smoke; means for detecting an absence of visible light, where the absence of visible light can be indicative of an attempt to prevent the detection of the flame and/or smoke; means for creating camouflage that has an appearance of an object used for a different purpose within the volume; and means for resisting shock that can be indicative of an attempt to prevent the detection of the flame and/or smoke. The means for detecting an absence of visible light can include means for generating electrical energy from the visible light that can be used to charge a power supply.

According to the sixth aspect, the means for transmitting an alarm notification can include means for transmitting an alarm notification to persons within the vicinity of the volume, using an audible alarm, a visual alarm and/or a tactile alarm, and means for transmitting the alarm notification to a remote monitor. The means for transmitting the alarm notification to the remote monitor can include means for generating an audible alarm, a visual alarm and/or a tactile alarm at the remote monitor's location, upon receipt of the alarm notification by the remote monitor, to indicate the alarm condition to the remote monitor. The system can also include means for transmitting a status message to the remote monitor at periodic intervals. The absence of receipt of the status message by the remote monitor within the periodic interval can be indicative of an alarm condition. In such a situation, means for generating an alarm condition can generate an audible alarm, a visual alarm and/or a tactile alarm at the location of the remote monitor to indicate the alarm condition to the remote monitor.

Thus, exemplary embodiments of the present invention can automatically monitor a volume, room or other space for the presence of a flame, smoke or fire. In such a volume, the presence of a flame, smoke or fire may be unintentional, or caused by an individual intentionally creating a flame for the purposes of, for example, causing a hazard to property or persons, lighting a cigarette where smoking is not permitted, and the like. To prevent detection of the flame, smoke or fire, the individual may deliberately attempt to counter the performance of the fire-sensing system. Measures to counter the performance of the system can include, for example, attempts to blind the system, attempts to damage the system, attempts to move or remove the system, and the like. According to exemplary embodiments, the fire-sensing system incorporates several means to negate these and other countermeasures. Upon the presence of an event, such as the detection of flame, smoke or fire or the detection of an attempt to tamper with or otherwise negate the performance of the system, an alerting signal can be sent to a monitor or other person or persons. The monitor or other person or persons can be located locally or remotely to the system. The alerting signal can be an audible, visual or tactile signal. The alerting signal can be sent via a wire or a wireless communications system if the monitor or other person is located remotely to the system.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a diagram illustrating a fire-sensing apparatus 100, in accordance with an exemplary embodiment of the present invention.

FIG. 2 is a block diagram illustrating an electronic configuration of the fire-sensing apparatus, in accordance with an exemplary embodiment of the present invention.

FIG. 3 is a flowchart illustrating steps performed by a low-power microcontroller of the fire-sensing apparatus, in accordance with an exemplary embodiment of the present invention.

FIG. 4 illustrates an outer enclosure of the fire-sensing apparatus, in accordance with an exemplary embodiment of the present invention.

FIG. 5 illustrates positioning of the fire-sensing apparatus within a volume, in accordance with an exemplary embodiment of the present invention.

FIG. 6 is a diagram illustrating a monitor module, in accordance with an exemplary embodiment of the present invention.

FIG. 7 is a block diagram illustrating components that can comprise the monitor module, in accordance with an exemplary embodiment of the present invention.

FIG. 8 is a flowchart illustrating steps performed by a low-power microcontroller in the monitor module, in accordance with an exemplary embodiment of the present invention.

FIG. 9 is a flowchart illustrating steps for sensing fire within a volume, in accordance with an exemplary embodiment of the present invention.

FIG. 10 is a flowchart illustrating steps for detecting a presence of flame within a volume, in accordance with an exemplary embodiment of the present invention.

FIG. 11 is a flowchart illustrating steps detecting tampering, in accordance with an exemplary embodiment of the present invention.

FIG. 12 is a flowchart illustrating steps for indicating an alarm condition, in accordance with an exemplary embodiment of the present invention.

### DETAILED DESCRIPTION OF THE PREFERRED EMBODIMENTS

Exemplary embodiments of the present invention are directed to a self-protected fire-sensing alarm system and method. According to exemplary embodiments, a volume, room or other space can be automatically monitored for the presence of a flame, smoke or fire. While the presence of a flame, smoke or fire in the volume may be unintentional, an individual may intentionally create a flame, smoke or fire in the volume for the purposes of, for example, causing a hazard to property or persons, lighting a cigarette where smoking is not permitted, and the like. Thus, the individual may deliberately attempt to counter the fire-sensing system's ability to detect the fire to prevent the system from detecting the flame or fire. Measures to counter the fire-sensing system can include, for example, attempts to blind the system, attempts to damage the system, attempts to move or remove the system, and the like. The self-protected fire-sensing system according to exemplary embodiments incorporates means to negate these and other countermeasures.

Upon the presence of an event, such as the detection of flame, smoke or fire within the volume or the detection of an attempt to tamper with or otherwise negate the performance of the system, an alerting signal can be sent to a monitor or other person or persons. The monitor or other person can be located locally or remotely to the system. The alerting signal can be an audible, visual or tactile signal that can be generated locally to the system (e.g., to alert persons within a vicinity of the system of the presence of the event). If the monitor or other person is located remotely to the system, the alerting signal can be sent via a wire or a wireless communications system, and the audible, visual or tactile signal can be generated remotely at the location of the monitor or other person to alert the monitor or other person of the presence of the event.

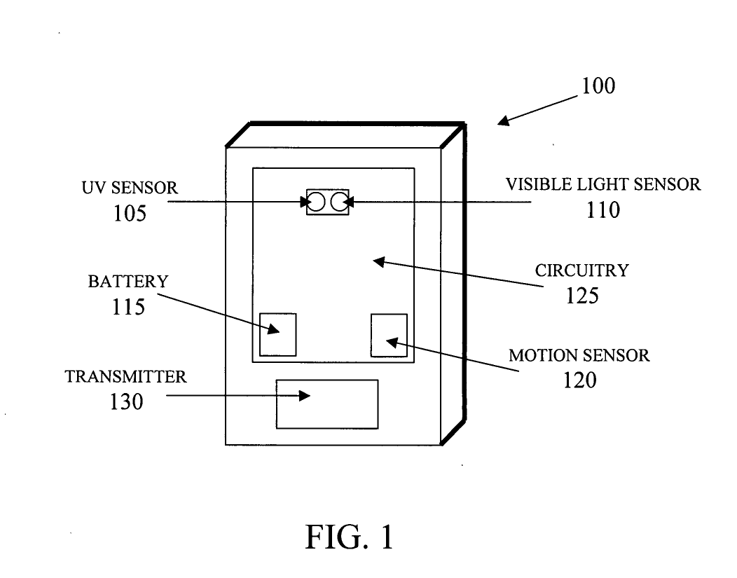

These and other aspects of the present invention will now be described in greater detail. FIG. 1 is a diagram illustrating a fire-sensing apparatus 100, in accordance with an exemplary embodiment of the present invention. The apparatus 100 can include a flame sensor for detecting the presence of flame with a volume. The flame sensor can be, for example, an ultraviolet sensor 105 that can detect ultraviolet energy generated by flame to detect the presence of flame within the volume. The ultraviolet sensor 105 can be insensitive to electromagnetic radiation that normally occurs within the volume. Thus, the ultraviolet sensor 105 can respond to ultraviolet radiation emitted from a flame from a lighter or match, but absent from standard incandescent or fluorescent lighting and absent from sunlight. Ultraviolet radiation reflects from most standard surfaces. Thus, the ultraviolet sensor 105 does not require line of sight to the flame. By detecting ultraviolet radiation instead of the visible light that normally occurs within a volume such as an enclosed room, the ultraviolet sensor 105 can be extremely sensitive to flames in a volume where flames are prohibited, and not subject to false alarms from standard lighting such as may be expected in the volume or room. Any electronic sensor that is capable of detecting ultraviolet radiation can be used for the ultraviolet sensor 105. However, any electronic sensor that is capable of detecting the presence of flame within a volume can be used for the flame sensor.

The apparatus 100 can include a tamper sensor for detecting tampering to the apparatus 100. The tampering prevents the apparatus 100 from detecting the presence of flame within the volume. For example, the tamper sensor can include a visible light sensor 110. Some level of visible light (e.g., sunlight, standard incandescent or fluorescent lighting, and the like) can be present in the volume of interest during the operation of the apparatus 100. Thus, an absence of visible light to the visible light sensor 110 can be indicative of an attempt to tamper with the apparatus 100. In other words, the absence of visible light can be an indication of deliberate attempts to blind the ultraviolet or flame sensor by covering some portion or all of apparatus 100, including visible light sensor 105, with an opaque object or any other material that blocks visible light from entering the visible light sensor 110. Any electronic sensor that is capable of detecting visible light can be used for visible light sensor 110.

According to an exemplary embodiment, the visible light sensor 105 can include means for generating electrical energy from the visible light. For example, a solar cell, photoelectric cell or any other electronic device that is capable of generating electricity from light can be used for the visible light sensor 110. According to such an exemplary embodiment, the visible light sensor 110 can generate electrical energy. Thus, the means for generating electrical energy from the visible light can supply electrical energy to charge a power supply for powering the apparatus 100. For example, the electrical energy can be used to extend the life of a rechargeable battery power supply 115, in addition or alternatively to an AC power supply connected to apparatus 100 or to the use of a non-rechargeable battery power supply (e.g., standard alkaline batteries). Alternatively, the means for generating electrical energy can supply electrical energy to power the apparatus 100.

According to an exemplary embodiment, the tamper sensor can include a motion sensor 120 for detecting motion to the apparatus 100. Some level of motion or movement to the apparatus 100 can be present if attempts are made to remove or move the apparatus 100. A detection of motion can be indicative of deliberate attempts to tamper with the apparatus 100 to prohibit the function of, for example, the ultraviolet sensor 105 by, for example, moving or removing the apparatus 100 from its position within the volume. Any electronic sensor that is capable of detecting motion can be used for motion sensor 120.

The apparatus 100 can include an alarm indicator for indicating an alarm condition in response to i.) the detection of the presence of flame within the volume and/or ii.) the detection of tampering to the apparatus 100. For example, electrical circuitry 125 can be used to manage and control the apparatus 100. The circuitry 125 can be any combination of hardware, firmware and software. For example, the circuitry 125 can include a processor, such as, for example, any type of microprocessor or microcontroller, and/or firmware, software, or any other type of electrical circuitry or any combination thereof. The circuitry 125 can also include any type of computer memory. The circuitry 125 can monitor for events indicative of a fire or flame, such as can be sensed via the ultraviolet sensor 105. The circuitry 125 can also monitor for deliberate attempts to degrade or otherwise negate the performance of apparatus 100, such as can be indicated by loss of visible light to visible light sensor 110 or detection of motion by motion sensor 120.

Upon detection of flame or fire and/or attempts at tampering with the apparatus 100, the circuitry 125 can indicate the alarm condition to persons within a vicinity of the apparatus 100. For example, the circuitry 125 can cause an audible alarm to be emitted through a speaker, buzzer, horn, siren or any other electrical device capable of emitting sound. Alternatively or additionally, the circuitry 125 can cause a visual alert to be emitted through a flashing light, a steady light, a strobe light, an alphanumeric display or any other electrical device capable of displaying a visual alert. Alternatively or additionally, the circuitry 125 can cause a tactile alert to be emitted by, for example, causing the apparatus 100 to vibrate using any type of electronic device that is capable of causing vibration.

Alternatively or additionally, the alarm condition can be sent to a monitor that is located remotely to the apparatus 100. Consequently, the apparatus 100 can include a transmitter for transmitting the alarm condition to a remote monitor. For example, the apparatus 100 can include a transmitter 130 for transmitting information via wireless radio communication. Any type of wireless transmitter unit can be used for transmitter 130 that is capable of wirelessly transmitting electrical information to a remote receiver using any type of information transmission protocol, such as, for example, a radio frequency transmitter and accompanying antenna. The apparatus 100 can also include a receiver for wirelessly receiving electrical information from a remote transmitter (e.g., a reset signal to reset apparatus 100 (e.g., after an alarm condition has been activated), a software and/or firmware update for circuitry 125 (e.g., if circuitry 125 is at least partially implemented using software and/or firmware), and the like). However, the apparatus 100 can also or alternatively be connected to a remote monitor via a wired electrical connection. The wired electrical connection that can be any type of wired electrical connection that is capable of communicating electrical information, such as a wire, cable, network connection, fiber optic connection, or any other type of wired electrical connection.

Thus, for example, using transmitter 130, upon detection of the presence of ultraviolet radiation by ultraviolet sensor 105, the circuitry 125 can transmit the alarm condition to the remote monitor, such as remotely monitoring person or persons. Upon the detection of the absence of visible light by visible light sensor 110, the circuitry 125 can transmit the alarm condition to the remote monitor. Upon the detection of the presence of motion by the motion sensor 120, the circuitry 125 can transmit the alarm condition to the remote monitor. The transmitted alarm condition can include information such as, for example, an identification code to identify a particular apparatus 100 when multiple volumes or rooms are being monitored by multiple apparatus 100, an indication of the type of event that caused the alarm condition, or any other type of information that can assist in alerting the remote monitor to the alarm condition and assist the remote monitor in assessing the situation.

The apparatus 100 can also include a smoke sensor for detecting the presence of smoke within the volume. Thus, upon detection of smoke within the volume, the circuitry 125 can transmit the alarm condition to the remote monitor and/or indicate the alarm condition to persons within the vicinity of the apparatus 100 using an audible alarm, a visual alarm and/or a tactile alarm. Any electronic sensor that is capable of detecting smoke can be used for the smoke sensor.

The transmitter 130 can also transmit a status message to the remote monitor at periodic intervals. The status message can be, for example, a binary code word, where each bit or bits in the code word can represent a particular piece of information (e.g., if a bit is set, then the information associated with that bit is true, otherwise it is false; a combination of bits can indicate a unique identifier). For example, by setting an appropriate bit in the status message code word, the status message can indicate that the apparatus 100 is performing as designed. However, the status message can be any type of electronic message. The status messages can be sent periodically, but pseudo-randomly. The transmission period can be varied to minimize message traffic collisions in the situation where multiple rooms are being monitored by different apparatus 100. The status message can include, for example, information for identifying the location of the source of the status message to the remote monitor (e.g., an identification code to identify a particular apparatus 100 when multiple volumes or rooms are being monitored by multiple apparatus 100), information for identifying the existence of an alarm condition to the remote monitor (e.g., a code indicating that the apparatus 100 detects no events or detects an event), information for identifying a type of alarm condition to the remote monitor (e.g., a code indicating if flame or fire has been detected or tampering to the apparatus 100 has been detected), or any other type of information that can assist the remote monitor in determining the status of the apparatus 100. Thus, the status message can include information that can be contained in the alarm condition, in addition or alternatively to the alarm condition.

According to exemplary embodiments, if the remote monitor does not receive a status message within a predetermined interval, then an alarm condition associated with apparatus 100 can be indicated. The cause of a missing status message can be, for example, a low battery (preventing effective information transmission), a defective apparatus 100, or a deliberate attempt to damage the apparatus 100.

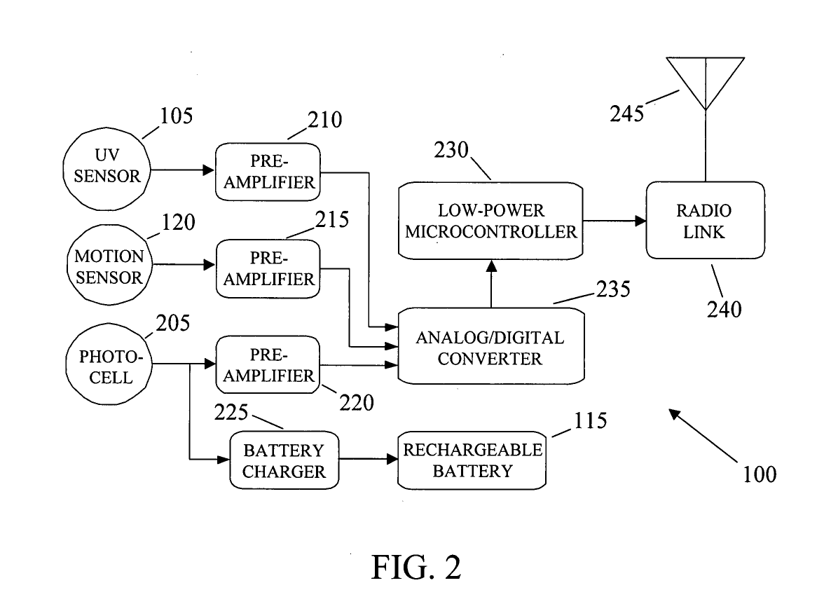

FIG. 2 is a block diagram illustrating an electronic configuration of the fire-sensing apparatus 100, in accordance with an exemplary embodiment of the present invention. Ultraviolet sensor 105 can be sensitive in the near-ultraviolet part of the spectrum and can be, for example, a solid state device or a gas ionization device. The ultraviolet sensor 105 can provide an electrical signal to preamplifier 210. Preamplifier 210 can perform necessary signal conditioning on the electrical signal prior to analog-to-digital (A/D) conversion by A/D converter 235. A motion sensor 120 can be included to detect tampering or other motion to the apparatus 100. The motion signal can be amplified by preamplifier 215 prior to A/D conversion by A/D converter 235.

Photocell 205 can serve multiple purposes. For example, the photocell 205 can detect visible light as a method of identifying tampering when visible light to the photocell 205 is blocked. The photocell 205 can output an electrical signal that can be amplified by preamplifier 220 and then digitized by A/D converter 235. The resulting signal can represent the intensity of visible light in the vicinity of the apparatus 100. Ultraviolet sensor 105 and photocell 205 can be configured or otherwise positioned in the apparatus 100 such that an attempt to block the ultraviolet sensor 105 will also block the photocell 205, indicating that tampering is likely. Photocell 205 can also supply current to battery charger 225 for recharging rechargeable battery 115. One or more photocells 205 can be selected to have sufficient output current to fully supply the power requirements of the apparatus 100.

The A/D converter 235 can send a multiplexed digital data stream to a low-power microcontroller 230. The low-power microcontroller 230 can be any type of processor, such as, for example, any type of microprocessor, microcontroller, digital signal processor (DSP), application-specific integrated circuit (ASIC), programmable read-only memory (PROM), erasable programmable read-only memory (EPROM), electrically-erasable programmable read-only memory (EEPROM), or the like, preferably one that operates at low power. The low-power microcontroller 230 can be connected to any form of computer memory, for example, to store computer instructions or other data or information. The low-power microcontroller 230 can perform, for example, data value measurements, range checking, and the like, and can execute the logic that determine whether an alarm, a tamper, or, for example, and an “ALL CLEAR” message should be transmitted via radio link 240 and antenna 245. Thus, circuitry 125 can include, for example, preamplifiers 210, 215 and 220, battery charger 225, low-power microcontroller 230 (and an accompanying computer memory, if desired) and A/D converter 235, while transmitter 130 can include radio link 240 and antenna 245. Additionally, status messages can be transmitted occasionally at intervals of, for example, five to ten seconds, or at any desired interval. The transmission interval can be randomized so that messages from multiple apparatus 100 do not persistently collide and interfere with each other.

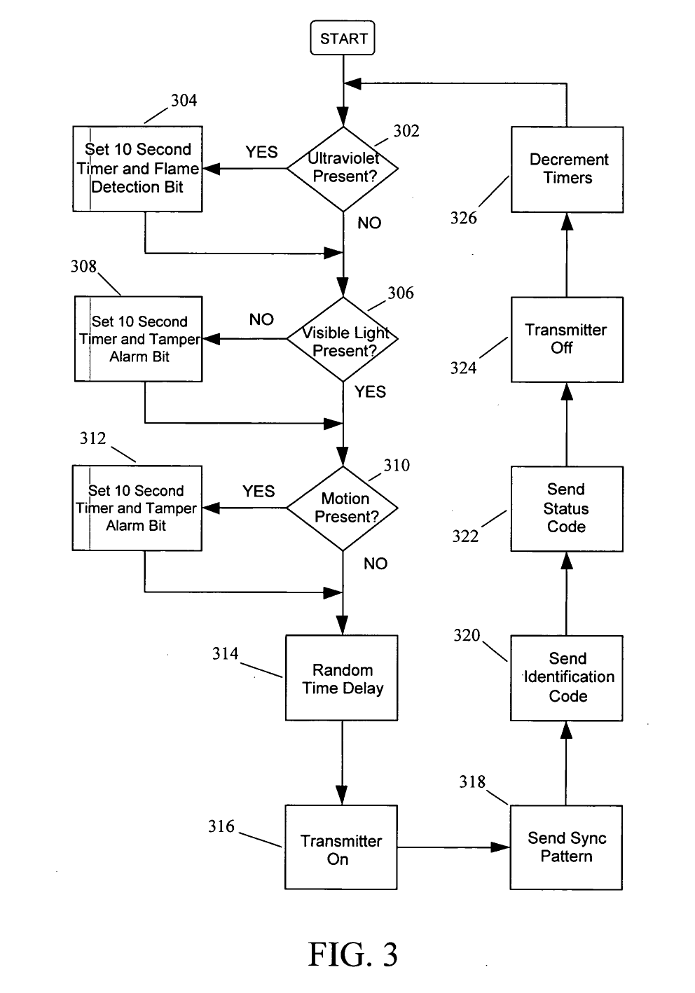

FIG. 3 is a flowchart illustrating steps that can be performed by the low-power microcontroller 230, in accordance with an exemplary embodiment of the present invention. In step 302, the digitized value from the ultraviolet sensor 105 can be compared with a threshold value to determine whether ultraviolet radiation is present. If ultraviolet radiation is present, then in step 304, a ten second timer (or any desired length timer) can be set and a bit in the status message code word can be set to indicate flame detection. As long as the timer value is greater than zero, this bit can remain set. In step 306, the digitized value of the photocell 205 voltage can be compared with a threshold value to determine if visible light is present. If the light intensity is below the threshold, then at least the photocell 205 has been blocked in an attempt to disable the apparatus 100. If visible light is not present, then in step 308, a ten second timer (or any desired length timer) can be set and another bit in the status message code word can be set to indicate tampering. This bit can remain set as long as the timer value is greater than zero. In step 310, the digitized value of the motion sensor 120 can be compared to a threshold value. If the motion intensity is greater than the threshold value, motion is present that indicative of tampering. In step 312, a ten second timer (or any desired length timer) can be set and a bit in the status message code word can be set to indicate tampering. This bit can remain set as long as the timer value is greater than zero.

After constructing the status message code word, in step 314, a random time delay can be generated. The random time delay can be used to vary the transmission period to minimize message traffic collisions in the situation where multiple volumes or rooms are being monitored by different apparatus 100. Once the random time delay has expired, the transmitter can be turned on in step 316. In step 318, a data synchronization pattern can be transmitted. The data synchronization pattern can be used by the receiver of the remote monitor to establish, for example, proper bit rate synchronization and word framing, and will depend on the type of communication protocol used to transmit the status message. In step 320, an identification code can be transmitted to distinguish which apparatus 100 is transmitting among a potentially large number of different apparatus 100. The identification code can be any type of information that can uniquely identify a particular apparatus 100. In step 322, the status message code word can be transmitted. In step 324, the transmitter can be turned off, for example, to conserve power. After transmitting the data, in step 326, all of the timers can be decremented by one second or any fixed amount of time appropriate to the length of the timer chosen. The process of measurement and evaluation can then be repeated starting at step 302.

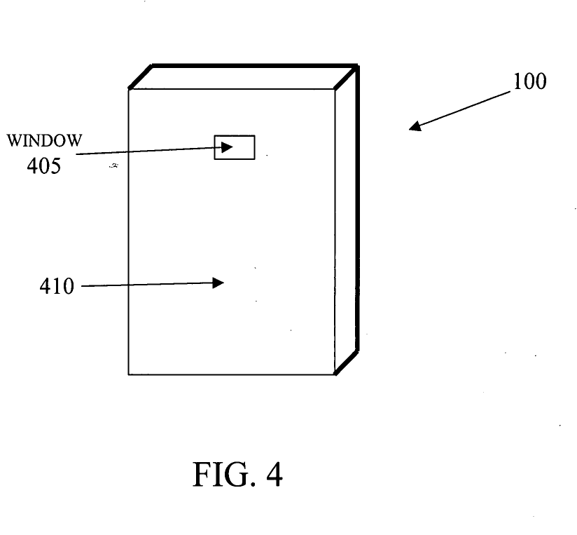

FIG. 4 illustrates an outer enclosure 410 of the fire-sensing apparatus 100, in accordance with an exemplary embodiment of the present invention. According to exemplary embodiments, the apparatus 100 can be of rugged construction, making it difficult to damage the apparatus 100 through means such as, for example, striking the apparatus 100 with a hard object. Thus, the apparatus 100 can have an enclosure 410 made of, for example, high-impact plastic or any other rugged material, so that the apparatus 100 can be resistant to shock, where shock to the apparatus 100 can be indicative of an attempt to tamper with the apparatus 100. The enclosure 410 can have a radiation transparent window 405 that allows visible light, ultraviolet radiation, and other electromagnetic radiation to pass through to the ultraviolet sensor 105 and the visible light sensor 110. The enclosure 410 can also have one or more slots or other openings to allow smoke to enter the enclosure 410 for the purpose of detecting smoke by the smoke sensor.

Additionally, the apparatus 100 can have the appearance of an object used for a different purpose within the volume, to camouflage the apparatus 100. For example, the apparatus 100 can be enclosed in an object typically present in the volume to conceal its intent, or the enclosure 410 can be shaped into the form and made to look like an object expected to be present in the volume or room of interest, such as a sprinkler head, light fixture, or other common device.

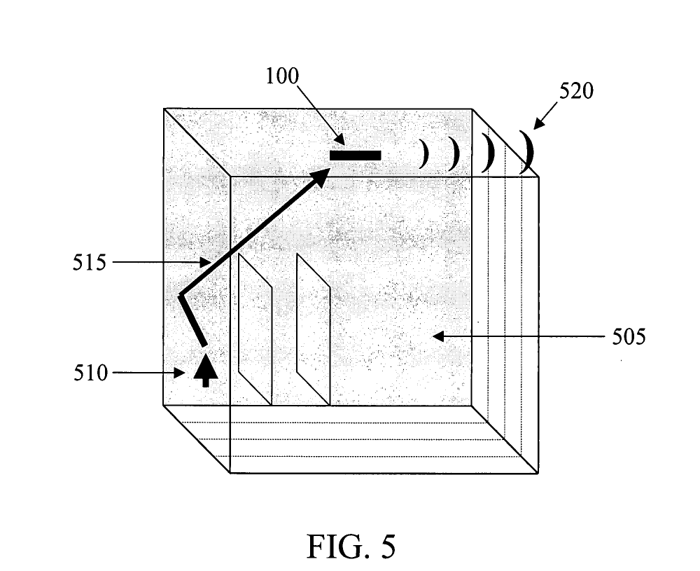

FIG. 5 illustrates positioning of the fire-sensing apparatus 100 within a volume, in accordance with an exemplary embodiment of the present invention. According to exemplary embodiments, the volume to be monitored by the apparatus 100 can be any volume, room or space, either open or enclosed, that can be monitored for the presence of flame, smoke or fire. The apparatus 100 can be positioned within the volume such that the apparatus 100 monitors substantially the entire contents of the volume. Multiple apparatus 100 can be positioned within the volume (and, for example, given the same identification) so as to provide complete or substantially complete coverage of the volume. For example, the apparatus 100 can be used in a restroom 505 of a public school, although the apparatus 100 can be used in any number of variations and configurations, such as, for example, in a restaurant, an aircraft seating area or rest room, or any number of other volumes where a fire or flame is prohibited but may be deliberately ignited. The apparatus 100 can be securely attached to, for example, a wall or ceiling. According to exemplary embodiments, a fire 510 causes an effect such as, for example, the emission of ultraviolet radiation 515 that can be detected at the apparatus 100. Upon the ignition of the fire 510 in the restroom 505 or upon an attempt to degrade or otherwise negate the performance of the apparatus 100, the apparatus 100 can detect such event and can communicate this information, for example, via wireless communication 520, to a monitor module that can be located remotely to the apparatus 100. The information can include information, for example, for identifying the location of the event in the instance where the facility has multiple volumes or rooms under surveillance. Upon receipt of the information, the remote monitor or other individual can be dispatched to investigate the restroom 505. The apparatus 100 can also or alternatively issue an audible, visible and/or tactile alert to persons within the vicinity of the apparatus 100 to indicate the alarm condition to the persons located near the apparatus 100.

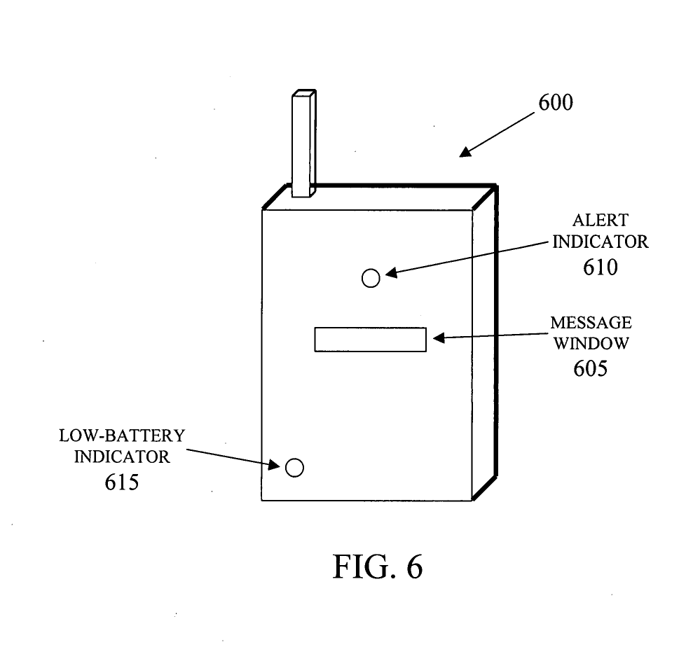

FIG. 6 is a diagram illustrating a monitor module, in accordance with an exemplary embodiment of the present invention. According to exemplary embodiments, an alarm condition can be transmitted to a remote monitor. The remote monitor can be any person or persons, located either locally or remotely to the apparatus 100, who have responsibility for overseeing the volume under surveillance and who are be notified upon detection of flame, smoke or fire and/or upon detection of tampering to the apparatus 100, such as, for example, security personnel, the fire department, the police department, and the like.

To notify the remote monitor, a monitor module 600 can be used. The monitor module 600 can provide a display or message window 605 (e.g., an alphanumeric display) and an alert indicator 610 (e.g., a light, LED, or other visual indicator) of the condition at the single or multiple volumes or rooms being monitored. Upon receipt of a periodic signal indicative of the wellness of apparatus 100, no alert need be indicated (e.g., alert indicator 610 does not flash or otherwise light up). However, upon the receipt of a signal indicative of an alarm condition, the monitor module 600 can generate an audible alarm (e.g., through a speaker, buzzer, horn, siren or the like), a visual alarm (e.g., a flashing light, a steady light, a strobe light, or the like via alert indicator 610, or an alphanumeric message display through message window 605), and/or a tactile alert (e.g., an electronic device that causes the monitor module 600 to vibrate) to indicate the alarm condition and alert the remote monitor. Additionally, based on the information contained in the signal received by the monitor module 600, the location of the event can be indicated to the remote monitor via the message window 605, such as, for example, by displaying a predefined identification code. Other information can be displayed to the remote monitor through message window 605, such as, for example, the type of event generating the alarm condition, or any other information that can assist in alerting the remote monitor to the alarm condition and that can be transmitted via a status message or alert notification.

According to exemplary embodiments, the absence of receipt of the status message by the remote monitor within the periodic interval can generate an audible alarm, a visual alarm and/or a tactile alarm at the location of the remote monitor to indicate the alarm condition to the remote monitor. The absence of the receipt of a scheduled periodic status message can be indicative of deliberate damage to the apparatus 100, or a low power (i.e. battery) condition at the apparatus 100. In either case, an audible, visual and/or tactile alarm signal can be generated by monitor module 600 to alert the remote monitor of the alarm condition resulting from the absence of receipt of the status message.

The monitor module 600 can be a portable unit that can be carried by the remote monitor, or a fixed unit that can be placed in a room generally in communication with the remote monitor. The portable unit embodiment can have, for example, a low battery indicator 615. The fixed unit embodiment can have, for example, a corresponding power indicator.

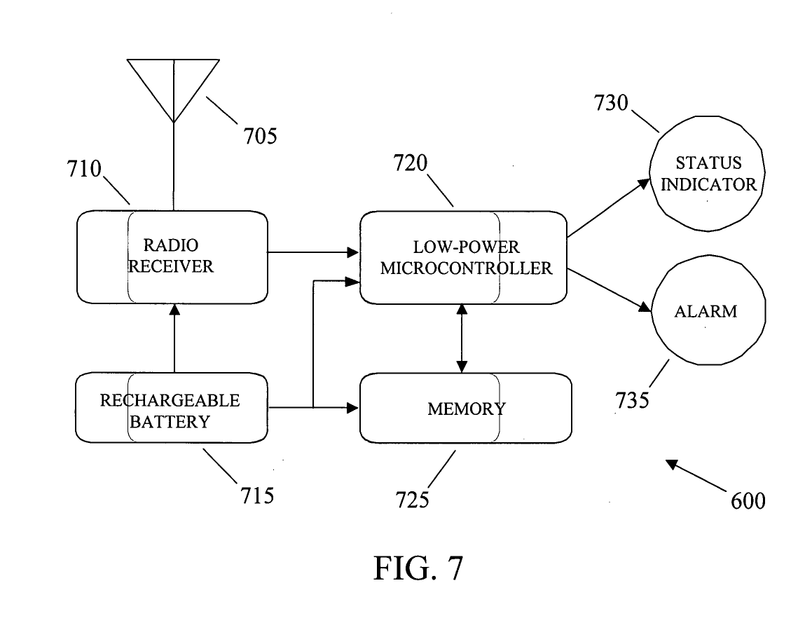

FIG. 7 is a block diagram illustrating components that can comprise the monitor module, in accordance with an exemplary embodiment of the present invention. Signals received from fire-sensing apparatus 100 by antenna 705 can be processed by radio receiver 710 to extract a digital bit stream representing transmissions from the apparatus 100. The radio receiver 710 can be any type of receiver that is capable of receiving wireless communications. For wired communications, a receiver that is capable of receiving electrical information over any type of wired transmission medium (e.g., a wire, cable, network connection, fiber optic cable, and the like) can be used. The bit stream can be sent to a low-power microcontroller 720 for analysis and reporting. The low-power microcontroller 720 can be any type of processor, such as, for example, any type of microprocessor, microcontroller, DSP, ASIC, PROM, EPROM, EEPROM, or the like, preferably one that operates at low power.

The status of all apparatus 100 being monitored by the monitor module 600 and a history of the status of each of the monitored apparatus 100 can be stored in a memory 725 in connection with the low-power microcontroller 720. The memory 725 can be any type of computer memory or any other type of electronic storage medium that is located either internally or externally to low-power microcontroller 720, such as, for example, read-only memory (ROM), random access memory (RAM), cache memory, compact disc read-only memory (CDROM), electro-optical memory, magneto-optical memory, or the like. As will be appreciated based on the present description, the memory 725 of low-power microcontroller 720 can, for example, be programmed using conventional techniques known to those having ordinary skill in the art of computer programming. For example, the actual source code or object code of a computer program for performing any or all of the functions described herein for low-power microcontroller 720 can be stored in the memory 725. The remote monitor using the monitor module 600 can access memory 725 to locate alarm and tampering events that occurred previously. For example, the remote monitor can access the information through message window 605 using any type of input access device, such as a keyboard or keypad, or any type of computer pointing device attached or otherwise connected to monitor module 600. Alternatively or additionally, status indicator 730 and alarm indicator 735 can display, for example, the most recent apparatus data. A rechargeable battery 715 can be used to power the radio receiver 710, low-power microcontroller 720 and memory 725, although non-rechargeable batteries or an AC power supply can be used to power monitor module 600.

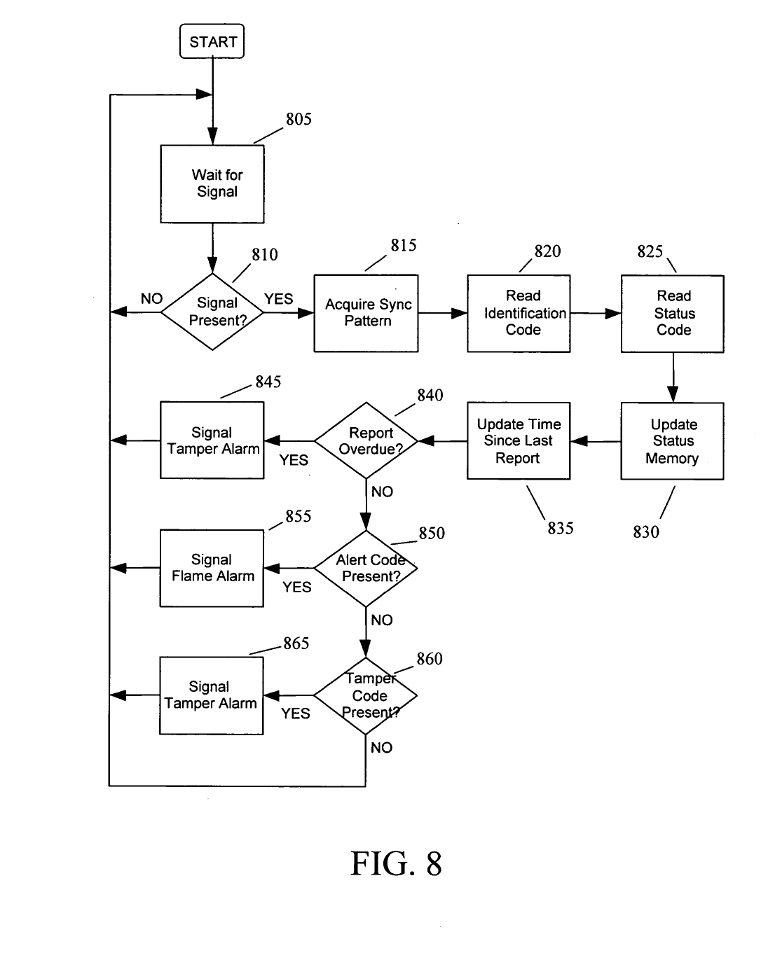

FIG. 8 is a flowchart illustrating steps that can be performed by the low-power microcontroller 720 in the monitor module 600, in accordance with an exemplary embodiment of the present invention. In step 805, the low-power microcontroller 720 can loop waiting for a signal from the radio receiver 710. When a signal is detected in step 810, the low-power microcontroller 720 can search for and acquire the synchronization pattern in step 815 to, for example, establish word boundaries. In step 820, the identification code can be read, while in step 825, the status code can be read. In step 830, the identification and status codes can be stored in the memory 725 along with, for example, the time that they were received, or any other desired information. In step 835, the memory 725 can be searched to retrieve the elapsed time from the last report for each apparatus 100. In step 840, if one or more reports have been missed from a particular apparatus 100, it can be considered overdue, for example, due to tampering. The tamper alarm can then be reported to the remote monitor in step 845. In step 850, the current report can be checked for the presence of a fire alarm code. If the fire alarm code is present, then in step 855, the flame alarm can be reported to the remote monitor. In step 860, the current report can be checked for the presence of a tamper code. If the tamper code is present, then in step 865, the tamper alarm can be reported to the remote monitor. The monitor module can then return to the search loop of step 805 to wait for the next signal.

According to an alternative exemplary embodiment of the present invention, a fire-sensing system can include a fire sensor for detecting the presence of flame and/or smoke within a volume. The fire sensor can include a flame sensor for detecting ultraviolet energy generated by flame to detect the presence of flame within the volume. However, the flame sensor can be insensitive to electromagnetic radiation that normally occurs within the volume, such as sunlight, standard incandescent or fluorescent lighting, and the like. For example, referring to FIG. 1, the ultraviolet sensor 105 can be used to detect the ultraviolet energy generated by flame, such as from a candle, a match, a lighter, or any other source of flame. However, any type of flame sensor can be used that is capable of detecting the presence of flame within the volume. The fire sensor can also include a smoke sensor for detecting the presence of smoke within the volume. Any type of smoke sensor can be used that is capable of detecting the presence of smoke within a volume.

According to the present alternative exemplary embodiment, the system can include tamper countering structure for countering attempts to prevent the fire sensor from detecting the presence of flame and/or smoke within the volume. The tamper countering structure can include, for example, a motion sensor 120 for detecting motion to the system. A detection of motion to the system can be indicative of an attempt to prevent the fire sensor from detecting the presence of flame and/or smoke within the volume.

The tamper countering structure can include, for example, a visible light sensor 110. An absence of visible light to the visible light sensor 110 can be indicative of an attempt to prevent the fire sensor from detecting the presence of flame and/or smoke within the volume. The visible light sensor 110 can include, for example, means for generating electrical energy from the visible light, such as, for example, a solar cell, a photoelectric cell, or any other electronic device that is capable of generating electrical energy from light. The means for generating electrical energy from visible light can supply electrical energy to charge a power supply used to power the system, such as, for example, rechargeable battery 115.

The tamper countering structure can include, for example, camouflage for camouflaging the appearance of the system. According to exemplary embodiments, the camouflage can provide the system with the appearance of an object used for a different purpose within the volume. For example, the system can be enclosed in a sprinkler head, light fixture or other common device to conceal its intent, or the system can be shaped into the form and made to look like such an object. The tamper countering structure can include, for example, a shock-resistant enclosure (such as enclosure 410 of FIG. 4) for the system for protecting the system against shock. A shock to the system, such as, for example, hitting the system with a hard object, can be indicative of an attempt to disable, damage or otherwise negate the performance of the system. Thus, the system can be enclosed in a rugged material, such as, for example, a high-impact plastic, to protect the system from such shocks.

According to the present alternative exemplary embodiment, the system can include a transmitter for transmitting an alarm notification upon detection of i.) the presence of flame and/or smoke within the volume, and/or ii.) an attempt to prevent the fire sensor from detecting the presence of flame and/or smoke within the volume. The transmitter can transmit the alarm notification to persons within the vicinity of the system using, for example, an audible alarm, a visual alarm, and/or a tactile alarm. Additionally or alternatively, the transmitter can transmit the alarm notification to a remote monitor. For example, transmitter 130 can be used to transmit the alarm notification to a remote monitor or other person or persons located remotely from the system. The alarm notification can be transmitted to the remote monitor via wireless or wired communication. Upon receipt of the alarm notification by the remote monitor, an audible alarm, a visual alarm and/or a tactile alarm can be generated at the location of the remote monitor to indicate the alarm notification to the remote monitor. For example, monitor module 600 can be used to generate the alarm to indicate the alarm notification to the remote monitor.

The transmitter can transmit a status message to the remote monitor at periodic intervals. The status message can include, for example, information for identifying the location of the source of the status message, information for identifying the existence of an alarm condition associated with the system, information for identifying the type of alarm condition associated with the system, or any other type of information that can assist the remote monitor in assessing the situation. According to the present alternative exemplary embodiment, if the remote monitor does not receive the status message within the periodic interval, then an alarm condition is indicated. Consequently, the absence of receipt of the status message by the remote monitor within the periodic interval can generate an audible alarm, a visual alarm, and/or a tactile alarm at the location of the remote monitor to indicate the alarm condition to the remote monitor.

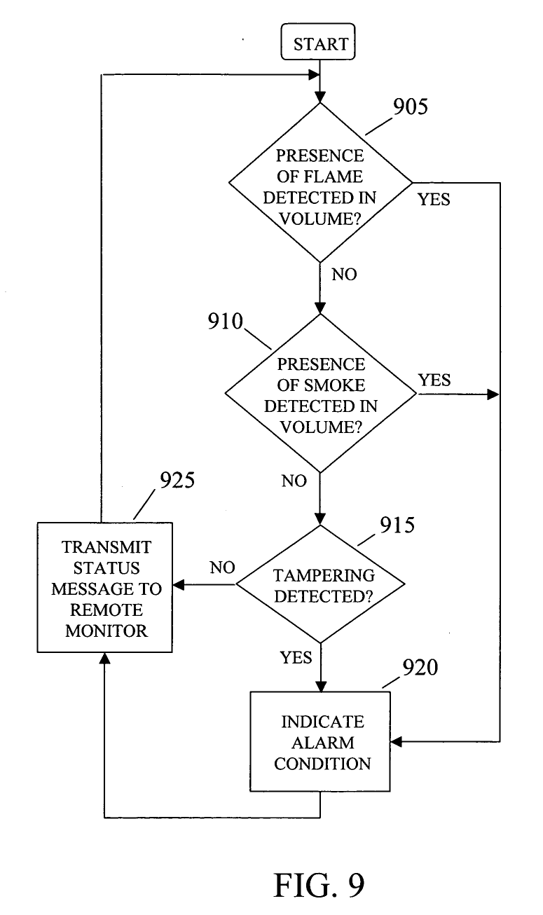

FIG. 9 is a flowchart illustrating steps for sensing fire within a volume, in accordance with an exemplary embodiment of the present invention. In step 905, the presence of flame within the volume can be detected. If the presence of flame is not detected in step 905, then in step 910 the presence of smoke within the volume can be detected. If the presence of smoke is not detected in step 910, then in step 915 tampering can be detected that prevents the detection of the presence of flame, smoke or fire within the volume. If no tampering is detected in step 915, then in step 925, a status message can be transmitted to a remote monitor at periodic intervals. The status message can indicate, for example, that no alarm conditions have been detected. If flame is detected in step 905, or smoke detected in step 910, or tampering detected in step 915, then in step 920, an alarm condition can be indicated. The indication of the alarm condition can form part of the status message transmitted to the remote monitor in step 925. For example, the status message can include, for example, information for identifying the location of the source of the status message, information for identifying the existence of the alarm condition, information for identifying the type of alarm condition, or any other information. Exemplary embodiments can then continue monitoring the volume at step 905.

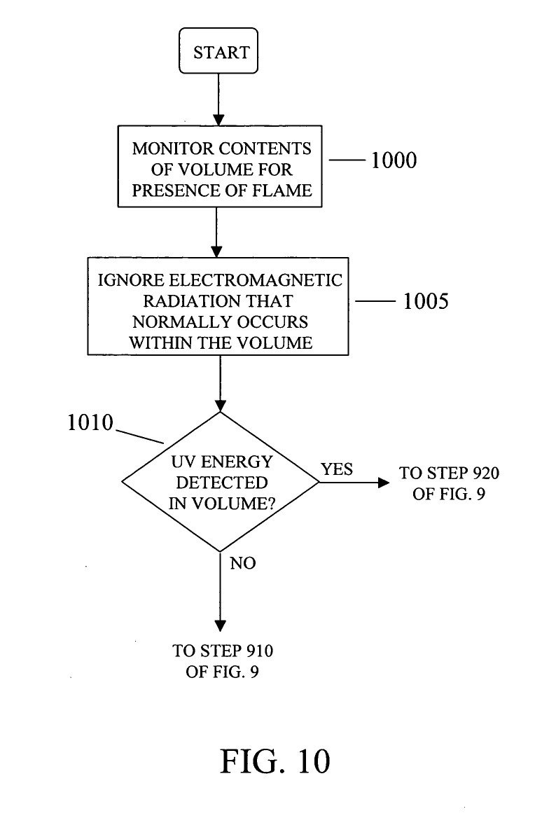

FIG. 10 is a flowchart illustrating steps for the step 905 of FIG. 9 of detecting a presence of flame within a volume, in accordance with an exemplary embodiment of the present invention. In step 1000, substantially the entire contents of the volume can be monitored for the presence of flame within the volume. In step 1005, electromagnetic radiation that normally occurs within the volume (e.g., sunlight, standard incandescent and fluorescent lighting, and the like) can be ignored. In step 1010, ultraviolet energy generated by flame can be detected. If ultraviolet energy is detected in step 1010, then an alarm condition can be indicated in step 920 of FIG. 9. Otherwise no flame has been detected and the process can continue with step 910 in FIG. 9.

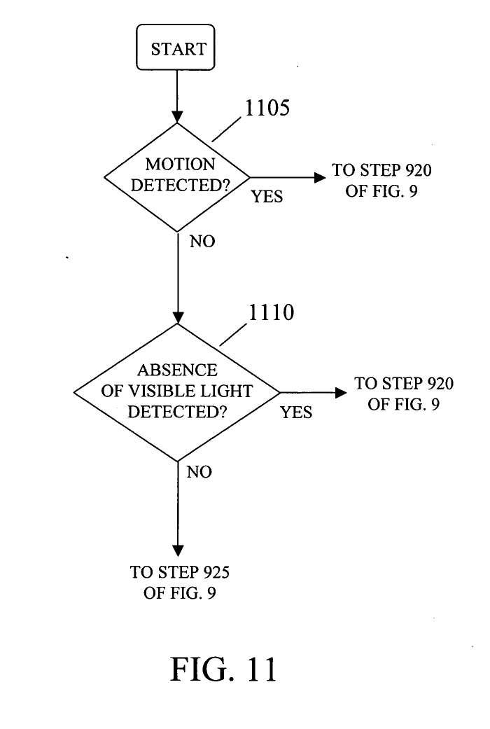

FIG. 11 is a flowchart illustrating steps for step 915 of FIG. 9 of detecting tampering, in accordance with an exemplary embodiment of the present invention. In step 1105, motion can be detected. The motion can indicate tampering that prevents the detection of the presence of flame, smoke or fire within the volume. If no motion is detected, then in step 1110, an absence of visible light can be detected. For step 1110, electrical energy can also be generated from the visible light. The generated electrical energy can be used to, for example, charge a power supply. If visible light is detected, then no tampering has been detected, and the process can continue with step 925 of FIG. 9. If motion or an absence of visible light is detected, then the process can continue with step 920 of FIG. 9 to indicate an alarm condition. Exemplary embodiments of the present invention can counter attempts at tampering that prevent the detection of the presence of flame, smoke or fire within the volume. For example, camouflage can be created that has the appearance of an object used for a different purpose within the volume, or shock can be resisted that can be indicative of attempts at tampering.

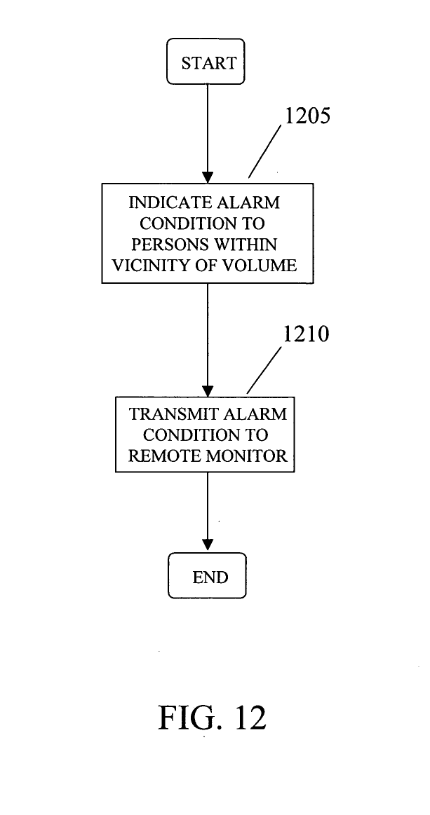

FIG. 12 is a flowchart illustrating steps for step 920 of FIG. 9 of indicating an alarm condition, in accordance with an exemplary embodiment of the present invention. In step 1205, the alarm condition can be indicated to persons within the vicinity of the volume using an audible alarm, a visual alarm and/or a tactile alarm. In step 1210, the alarm condition can be transmitted to a remote monitor. Upon receipt of the alarm condition by the remote monitor, an audible alarm, a visual alarm and/or a tactile alarm can be generated at the location of the remote monitor to indicate the alarm condition to the remote monitor. In addition, according to exemplary embodiments, the absence of receipt of the status message by the remote monitor within the periodic interval can be indicative of an alarm condition. Therefore, if the remote monitor does not receive the status message within the periodic interval, an audible alarm, visual alarm and/or tactile alarm can be generated at the location of the remote monitor to indicate the alarm condition to the remote monitor.

The steps of a computer program as illustrated in FIGS. 3 and 8-12 can be embodied, in whole or at least in part, in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and applications, foreign patents, and publications discussed above are hereby incorporated herein by reference in their entireties.

1. A fire-sensing apparatus, comprising:
a flame sensor for detecting a presence of flame within a volume;
a tamper sensor for detecting tampering to the apparatus, wherein the tampering prevents the apparatus from detecting the presence of flame within the volume; and
an alarm indicator for indicating an alarm condition in response to at least one of i.) a detection of the presence of flame within the volume, and ii.) a detection of tampering to the apparatus.

2. The apparatus of claim 1, wherein the flame sensor detects ultraviolet energy generated by flame to detect the presence of flame within the volume.

3. The apparatus of claim 2, wherein the flame sensor has an absence of sensitivity to electromagnetic radiation that normally occurs within the volume.

4. The apparatus of claim 1, further comprising:
a smoke sensor for detecting a presence of smoke within the volume, wherein the alarm indicator further indicates the alarm condition in response to a detection of the presence of smoke within the volume.

5. The apparatus of claim 1, wherein the tamper sensor comprises:
a motion sensor for detecting motion to the apparatus, wherein a detection of motion to the apparatus is indicative of an attempt to tamper with the apparatus.

6. The apparatus of claim 1, wherein the tamper sensor comprises:
a visible light sensor, wherein an absence of visible light to the visible light sensor is indicative of an attempt to tamper with the apparatus.

7. The apparatus of claim 6, wherein the visible light sensor comprises:
means for generating electrical energy from the visible light, wherein the means for generating electrical energy from the visible light supplies electrical energy to charge a power supply for powering the apparatus.

8. The apparatus of claim 1, wherein the alarm indicator indicates the alarm condition to persons within a vicinity of the apparatus using at least one of an audible alarm, a visual alarm and a tactile alarm.

9. The apparatus of claim 1, comprising:
a transmitter for transmitting the alarm condition to a remote monitor.

10. The apparatus of claim 9, wherein receipt of the alarm condition by the remote monitor generates at least one of an audible alarm, a visual alarm and a tactile alarm at a location of the remote monitor to indicate the alarm condition to the remote monitor.

11. The apparatus of claim 9, wherein the transmitter transmits a status message to the remote monitor at periodic intervals.

12. The apparatus of claim 11, wherein an absence of receipt of the status message by the remote monitor within the periodic interval is indicative of an alarm condition associated with the apparatus, and
wherein an absence of receipt of the status message by the remote monitor within the periodic interval generates at least one of an audible alarm, a visual alarm and a tactile alarm at a location of the remote monitor to indicate the alarm condition to the remote monitor.

13. The apparatus of claim 11, wherein the status message includes information for identifying a location of a source of the status message to the remote monitor.

14. The apparatus of claim 11, wherein the status message includes information for identifying an existence of the alarm condition to the remote monitor.

15. The apparatus of claim 11, wherein the status message includes information for identifying a type of alarm condition to the remote monitor.

16. The apparatus of claim 1, wherein the apparatus has an appearance of an object used for a different purpose within the volume, to camouflage the apparatus.

17. The apparatus of claim 1, wherein the apparatus is resistant to shock, wherein shock to the apparatus is indicative of an attempt to tamper with the apparatus.

18. The apparatus of claim 1, wherein the apparatus is positioned within the volume such that the apparatus monitors substantially an entire contents of the volume.

19. A fire-sensing system, comprising:
a fire sensor for detecting a presence of at least one of flame and smoke within a volume;
tamper countering structure for countering attempts to prevent the fire sensor from detecting the presence of the at least one of flame and smoke within the volume; and
a transmitter for transmitting an alarm notification upon detection of at least one of i.) the presence of at least one of flame and smoke within the volume, and ii.) an attempt to prevent the fire sensor from detecting the presence of the at least one of flame and smoke within the volume.

20. The system of claim 19, wherein the fire sensor comprises:
a flame sensor for detecting ultraviolet energy generated by flame to detect the presence of flame within the volume; and
a smoke sensor for detecting the presence of smoke within the volume.

21. The system of claim 20, wherein the flame sensor has an absence of sensitivity to electromagnetic radiation that normally occurs within the volume.

22. The system of claim 19, wherein the tamper countering structure comprises:
a motion sensor for detecting motion to the system, wherein a detection of motion to the system is indicative of an attempt to prevent the fire sensor from detecting the presence of the at least one of flame and smoke within the volume.

23. The system of claim 19, wherein the tamper countering structure comprises:
a visible light sensor, wherein an absence of visible light to the visible light sensor is indicative of an attempt to prevent the fire sensor from detecting the presence of the at least one of flame and smoke within the volume.

24. The system of claim 23, wherein the visible light sensor comprises:
means for generating electrical energy from the visible light, wherein the means for generating electrical energy from the visible light supplies electrical energy to charge a power supply used to power the system.

25. The system of claim 19, wherein the tamper countering structure comprises:
camouflage for camouflaging an appearance of the system, wherein the camouflage provides the system with the appearance of an object used for a different purpose within the volume.

26. The system of claim 19, wherein the tamper countering structure comprises:
a shock-resistant enclosure for the system for protecting the system against shock.

27. The system of claim 19, wherein the transmitter transmits the alarm notification to persons within a vicinity of the system using at least one of an audible alarm, a visual alarm and a tactile alarm.

28. The system of claim 19, wherein the transmitter transmits the alarm notification to a remote monitor.

29. The system of claim 28, wherein receipt of the alarm notification by the remote monitor generates at least one of an audible alarm, a visual alarm and a tactile alarm at a location of the remote monitor to indicate the alarm notification to the remote monitor.

30. The system of claim 19, wherein the transmitter transmits a status message to a remote monitor at periodic intervals.

31. The system of claim 30, wherein the status message includes information for identifying a location of a source of the status message to the remote monitor.

32. The system of claim 30, wherein the status message includes information for identifying an existence of an alarm condition associated with the system to the remote monitor.

33. The system of claim 30, wherein the status message includes information for identifying a type of an alarm condition associated with the system to the remote monitor.

34. The system of claim 30, wherein an absence of receipt of the status message by the remote monitor within the periodic interval is indicative of an alarm condition associated with the system, and
wherein an absence of receipt of the status message by the remote monitor within the periodic interval generates at least one of an audible alarm, a visual alarm and a tactile alarm at a location of the remote monitor to indicate the alarm condition to the remote monitor.

35. A method for sensing fire within a volume, comprising the steps of:
detecting a presence of flame within the volume;
detecting tampering that prevents a detection of the presence of flame within the volume; and
indicating an alarm condition in response to at least one of i.) the detection of the presence of flame within the volume, and ii.) the detection of tampering that prevents the detection of the presence of the flame within the volume.

36. The method of claim 35, wherein the step of detecting a presence of flame within the volume comprises the steps of:
detecting ultraviolet energy generated by flame; and
ignoring electromagnetic radiation that normally occurs within the volume.

37. The method of claim 35, comprising the step of:
detecting a presence of smoke within the volume,
wherein the step of indicating an alarm condition further comprises the step of:
indicating the alarm condition in response to a detection of the presence of smoke within the volume.

38. The method of claim 35, wherein the step of detecting tampering comprises the step of:
detecting motion, wherein the motion indicates tampering that prevents the detection of the presence of the flame within the volume.

39. The method of claim 35, wherein the step of detecting tampering comprises the step of:
detecting an absence of visible light, wherein the absence of visible light indicates tampering that prevents the detection of the presence of the flame within the volume.

40. The method of claim 39, wherein the step of detecting an absence of visible light comprises the step of:
generating electrical energy from the visible light, wherein the generated electrical energy supplies electrical energy to charge a power supply.

41. The method of claim 35, wherein the step of indicating an alarm condition comprises the step of:
indicating the alarm condition to persons within a vicinity of the volume using at least one of an audible alarm, a visual alarm and a tactile alarm.

42. The method of claim 35, wherein the step of indicating an alarm condition comprises the step of:
transmitting the alarm condition to a remote monitor.

43. The method of claim 42, wherein the step of transmitting the alarm condition to a remote monitor comprises the step of:
generating at least one of an audible alarm, a visual alarm and a tactile alarm at a location of the remote monitor, upon receipt of the alarm condition by the remote monitor, to indicate the alarm condition to the remote monitor.

44. The method of claim 35, comprising the step of:
transmitting a status message to a remote monitor at periodic intervals.

45. The method of claim 44, wherein an absence of receipt of the status message by the remote monitor within the periodic interval is indicative of an alarm condition, and
wherein the step of transmitting the status message comprises the step of:
generating at least one of an audible alarm, a visual alarm and a tactile alarm at a location of the remote monitor, upon absence of receipt of the status message by the remote monitor within the periodic interval, to indicate the alarm condition to the remote monitor.

46. The method of claim 44, wherein the status message includes information for identifying a location of a source of the status message to the remote monitor.

47. The method of claim 44, wherein the status message includes information for identifying an existence of the alarm condition to the remote monitor.

48. The method of claim 44, wherein the status message includes information for identifying a type of the alarm condition to the remote monitor.

49. The method of claim 35, comprising the step of:
countering attempts at tampering that prevent the detection of the presence of flame within the volume.

50. The method of claim 49, wherein the step of countering attempts at tampering comprises the step of:
creating camouflage that has an appearance of an object used for a different purpose within the volume.

51. The method of claim 49, wherein the step of countering comprises the step of:
resisting shock that is indicative of attempts at tampering.

52. The method of claim 35, wherein the step of detecting a presence of flame within the volume comprises the steps of:
monitoring substantially an entire contents of the volume for the presence of flame within the volume.

53. A method for sensing fire within a volume, comprising the steps of:
detecting a presence of at least one of flame and smoke within the volume;
countering attempts to prevent a detection of the presence of the at least one of flame and smoke within the volume; and
transmitting an alarm notification upon detection of at least one of i.) the presence of the at least one of flame and smoke within the volume, and ii.) an attempt to prevent the detection of the presence of the at least one of flame and smoke within the volume.

54. The method of claim 53, wherein the step of detecting a presence of at least one of flame and smoke within the volume comprises the steps of:
detecting ultraviolet energy generated by flame to detect the presence of flame within the volume;
ignoring electromagnetic radiation that normally occurs within the volume; and
detecting the presence of smoke within the volume.

55. The method of claim 53, wherein the step of countering attempts comprises the step of:
detecting motion, wherein a detection of motion is indicative of an attempt to prevent the detection of the presence of at least one of flame and smoke within the volume.

56. The method of claim 53, wherein the step of countering attempts comprises the step of:
detecting an absence of visible light, wherein the absence of visible light is indicative of an attempt to prevent the detection of the presence of at least one of flame and smoke within the volume.

57. The method of claim 56, wherein the step of detecting an absence of visible light comprises the step of:
generating electrical energy from the visible light, wherein the generated electrical energy supplies electrical energy to charge a power supply.

58. The method of claim 53, wherein the step of countering attempts comprises the step of:
creating camouflage that has an appearance of an object used for a different purpose within the volume.

59. The method of claim 53, wherein the step of countering attempts comprises the step of:
resisting shock that is indicative of an attempt to prevent the detection of the presence of the at least one of flame and smoke within the volume.

60. The method of claim 53, wherein the step of transmitting an alarm notification comprises the step of:
transmitting the alarm notification to persons within a vicinity of the volume using at least one of an audible alarm, a visual alarm and a tactile alarm.

61. The method of claim 53, wherein the step of transmitting an alarm notification comprises the step of:
transmitting the alarm notification to a remote monitor.

62. The method of claim 61, wherein the step of transmitting the alarm notification to a remote monitor comprises the step of:
generating at least one of an audible alarm, a visual alarm and a tactile alarm at a location of the remote monitor, upon receipt of the alarm notification by the remote monitor, to indicate an alarm condition to the remote monitor.

63. The method of claim 53, comprising the step of:
transmitting a status message to a remote monitor at periodic intervals.

64. The method of claim 63, wherein the status message includes information for identifying a location of a source of the status message to the remote monitor.

65. The method of claim 63, wherein the status message includes information for identifying an existence of an alarm condition to the remote monitor.

66. The method of claim 63, wherein the status message includes information for identifying a type of an alarm condition to the remote monitor.

67. The method of claim 63, wherein an absence of receipt of the status message by the remote monitor within the periodic interval is indicative of an alarm condition, and
wherein the step of transmitting the status message comprises the step of:
generating at least one of an audible alarm, a visual alarm and a tactile alarm at a location of the remote monitor to indicate the alarm condition to the remote monitor.
